(19) United States
(12) Patent Application Publication
(10) Pub. No.: US 2025/0239795 A1
(43) Pub. Date: Jul. 24, 2025

(54) ELECTRICAL CONNECTOR ASSEMBLY AND WIRE END CONNECTOR THEREOF

(71) Applicant: BELLWETHER ELECTRONIC CORP., Taoyuan City (TW)

(72) Inventors: YUNG-LIANG CHI, Taoyuan City (TW); Ming-Hsun Yang, Taoyuan City (TW)

(21) Appl. No.: 18/978,082

(22) Filed: Dec. 12, 2024

Related U.S. Application Data
(60) Provisional application No. 63/555,467, filed on Feb. 20, 2024.
(60) Provisional application No. 63/623,532, filed on Jan. 22, 2024.

(51) Int. Cl. H01R 12/79; H01R 12/77; H01R 13/506; H01R 13/627; H01R 13/633

(52) U.S. Cl. CPC H01R 12/79; H01R 12/774; H01R 13/506; H01R 13/6275; H01R 13/6335

(57) ABSTRACT

An electrical connector assembly includes a wire end connector and a board end connector. The board end connector includes a first housing, a slot, and a plurality of conductive terminals. The conductive terminals are disposed in the slot. The wire end connector is detachably connected to the board end connector. The board end connector includes a second housing and a tongue plate. The wire end connector has four sidewalls that define an accommodating space. The tongue plate is disposed in the accommodating space. The tongue plate is connected to a cable assembly, and a surface of the tongue plate is provided with a plurality of contact pads. When the board end connector is docked with the wire end connector, the tongue plate is inserted into the slot, so that the contact pads electrical contact the conductive terminals, and the first housing is inserted into the accommodating space.

### CROSS-REFERENCE TO RELATED PATENT APPLICATION

This application claims the benefit of priority to the U.S. Provisional Patent Application Ser. No. 63/555,467, filed on Feb. 20, 2024, Ser. No. 63/623,532, filed on Jan. 22, 2024, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an electrical connector assembly and a wire end connector thereof, and more particularly to an electrical connector assembly and a wire end connector thereof capable of enhancing the stability of signal transmission.

### BACKGROUND OF THE DISCLOSURE

A wire end connector and a board end connector are engaged with each other, so that the conductive terminals inside the two connectors are electrically connected to achieve the purpose of signal transmission. Generally, the stability of the structural engagement between the wire end connector and the board end connector affects the stability of signal transmission. However, during installation of the existing wire end connector in a system, cables connected to the existing wire end connector need to be prone to bending due to insufficient accommodating space of the system, or to sagging due to gravity, causing the wire end connector to be shaken or pulled, which can result in unstable signal transmission.

Therefore, how to overcome the above-mentioned problem through an improvement in structural design has become an important issue to be addressed in the related art.

### SUMMARY OF THE DISCLOSURE

In response to the above-referenced technical inadequacies, the present disclosure provides an electrical connector assembly and a wire end connector thereof.

In order to solve the above-mentioned problems, one of the technical aspects adopted by the present disclosure is to provide an electrical connector assembly, which includes a board end connector and a wire end connector. The board end connector is used for being electrically connected a circuit board. The board end connector includes a first housing, a slot, and a plurality of conductive terminals. The plurality of conductive terminals are disposed in the slot. The wire end connector is detachably docked with the board end connector. The wire end connector includes a second housing and a tongue plate. The wire end connector has four sidewalls to jointly define an accommodating space. The tongue plate is disposed in the accommodating space and used for being connected to a cable assembly, and a surface of the tongue plate is provided with a plurality of contact pads. When the board end connector is docked with the wire end connector, the tongue plate is inserted into the slot, such that the plurality of contact pads electrically contact the plurality of conductive terminals, and the first housing is inserted into the accommodating space.

In order to solve the above-mentioned problems, another one of the technical aspects adopted by the present disclosure is to provide a wire end connector, which includes a housing assembly, a tongue plate, and an elastic buckle. The housing assembly has four sidewalls to enclose an accommodating space. A part of the tongue plate is disposed in the housing assembly and electrically connected to a cable assembly, and another part of the tongue plate is exposed from the accommodating space and provided with a plurality of contact pads. The elastic buckle includes a fixing end and a free end. The fixing end is fixed on the housing assembly and located in the accommodating space, and the free end protrudes from the four sidewalls.

Therefore, in the electrical connector assembly and the wire end connector thereof provided by the present disclosure, through the structural design of the second housing at least partially covering the first housing, the structural engagement of the board end connector docking with the wire end connector can be strengthened, so as to improve the stability of signal transmission.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a wire end connector according to a first embodiment of the present disclosure;

FIG. 2 is a partial schematic exploded view of the wire end connector according to the first embodiment of the present disclosure;

FIG. 3 is a schematic cross-sectional view taken along line III-III of FIG. 1.

FIG. 4 is a schematic exploded view of the wire end connector according to the first embodiment of the present disclosure;

FIG. 5 is a schematic view of a first implementation of the wire end connector and a board end connector according to the first embodiment of the present disclosure;

FIG. 6 is a schematic view of the board end connector according to the first embodiment of the present disclosure;

FIG. 7 is a schematic view of a first implementation of the wire end connector being docked with the board end connector according to the first embodiment of the present disclosure;

FIG. 8 is a schematic view of a second implementation of the wire end connector and the board end connector according to the first embodiment of the present disclosure;

FIG. 9 is a schematic view of a wire end connector according to a second embodiment of the present disclosure;

FIG. 10 is a schematic cross-sectional view of the wire end connector according to the second embodiment of the present disclosure;

FIG. 11 is a schematic view of the wire end connector and a board end connector according to the second embodiment of the present disclosure;

FIG. 12 is a schematic view of a wire end connector according to a third embodiment of the present disclosure;

FIG. 13 is a partial schematic exploded view of the wire end connector according to the third embodiment of the present disclosure; and

FIG. 14 is a schematic view of the wire end connector and a board end connector according to the third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

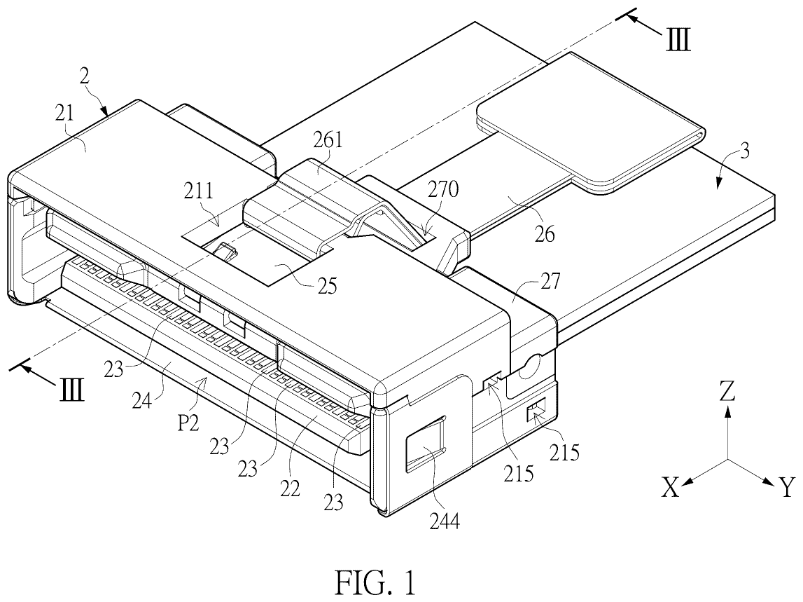

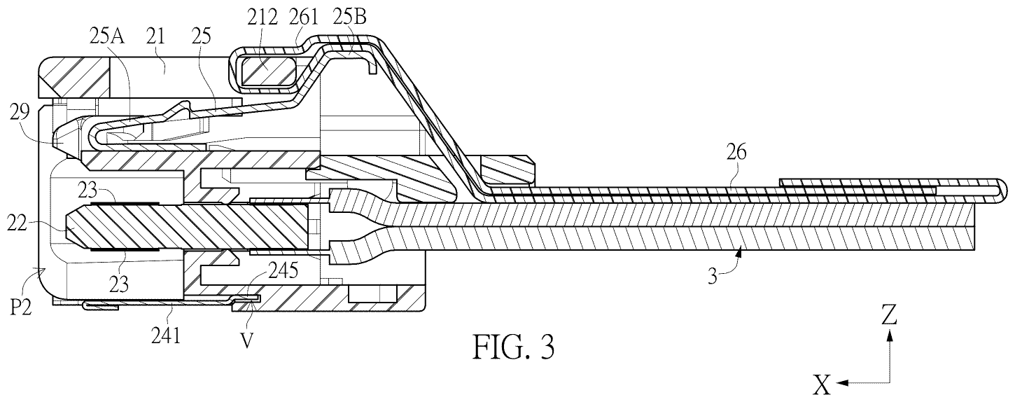

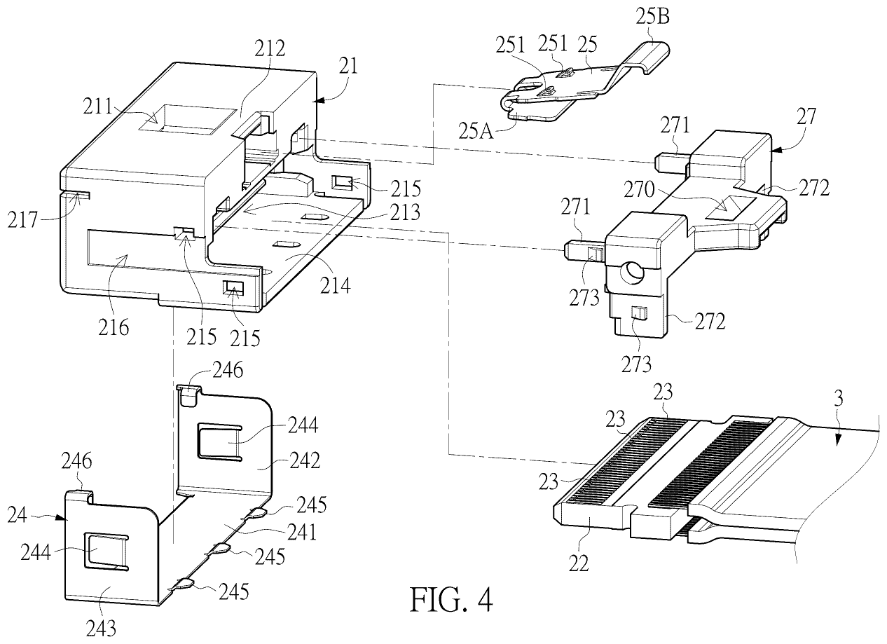

Reference is made to FIG. 1, FIG. 3, and FIG. 4. FIG. 1 is a schematic view of a wire end connector according to a first embodiment of the present disclosure. FIG. 3 is a schematic cross-sectional view taken along line III-III of FIG. 1. A wire end connector 2 includes a second housing 21 and a tongue plate 22. The second housing 21 has a second accommodating space P2. A part of the tongue plate 22 is disposed in the second housing 21 and connected to a cable assembly 3 (e.g., a flat cable), and another part of the tongue plate 22 is exposed to the second accommodating space P2. An upper surface and a lower surface of the exposed part of the tongue plate 22 are provided with a plurality of contact pads 23, which are commonly known as gold fingers.

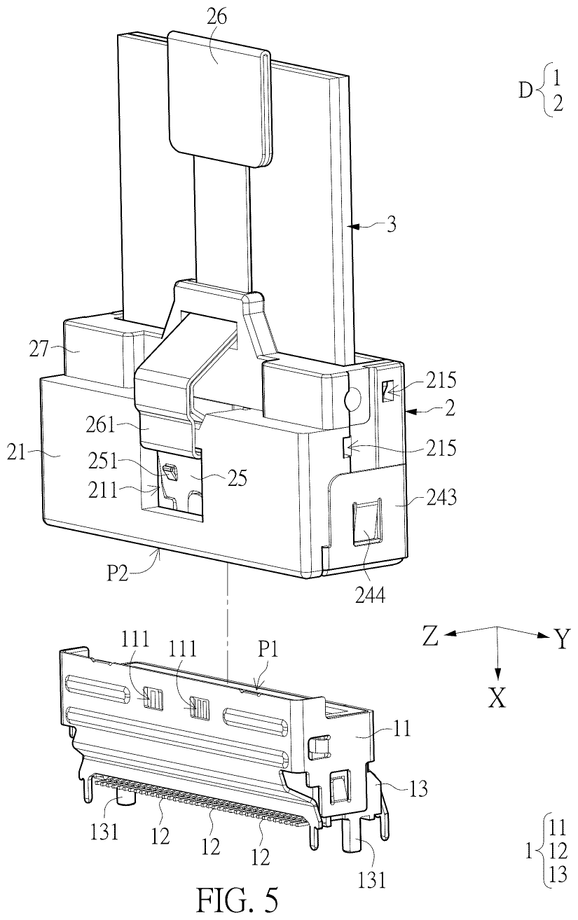

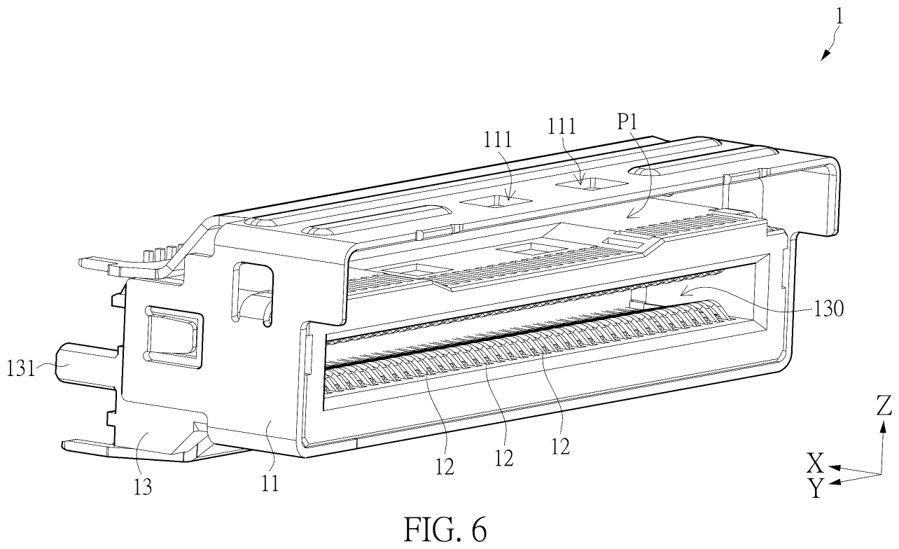

Reference is made to FIG. 5 and FIG. 6. FIG. 5 is a schematic view of the wire end connector and a board end connector according to the first embodiment of the present disclosure. FIG. 6 is a schematic view of the board end connector according to the first embodiment of the present disclosure. An electrical connector assembly D further includes a board end connector 1 and the wire end connector 2. The board end connector 1 includes a first housing 11, a plurality of conductive terminals 12, and a terminal base 13. The terminal base 13 is made of insulative material and has a slot 130. The plurality of conductive terminals 12 are fixed on the terminal base 13. One end of each of the conductive terminals 12 is located in the slot 130, and another end of each of the conductive terminals 12 is exposed from the terminal base 13 to form a pin. The first housing 11 is made of conductive material and covers an exterior of the terminal base 13. The board end connector 1 is fixed on a circuit board (not shown in the figures) through a plurality of fixing posts 131 of the terminal base 13.

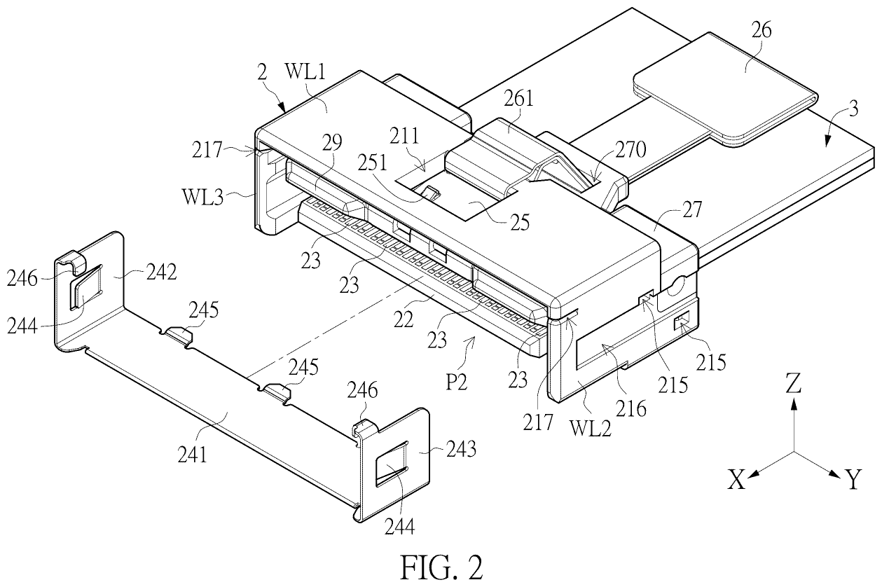

Reference is made to FIG. 2. FIG. 2 is a partial schematic exploded view of the wire end connector according to the first embodiment of the present disclosure. The wire end connector 2 further includes a metal frame 24. The metal frame 24 is detachably assembled to the second housing 21, and the second housing 21 is an insulative housing. The second housing 21 includes a first sidewall WL1, a second sidewall WL2, and a third sidewall WL3. The metal frame 24 and the second housing 21 jointly form a housing assembly. Specifically, the second accommodating space P2 of the second housing 21 is enclosed by four sidewalls. That is, the first sidewall WL1, the second sidewall WL2, the third sidewall WL3, and the metal frame 24 jointly define the second accommodating space P2. The first sidewall WL1 is vertically connected between the second sidewall WL2 and the third sidewall WL3. As shown in FIGS. 2 and 6, when the wire end connector 2 is docked with the board end connector 1, a portion of the first housing 11 is inserted into the second accommodating space P2. In the meantime, the second housing 21 only surrounds three sides of the first housing 11 by the first sidewall WL1, the second sidewall WL2, and the third sidewall WL3. That is, only three of the four sides of the first housing 11 are covered by an existing second housing 21.

By assembling the metal frame 24 of the first embodiment onto the second housing 21, the metal frame 24 becomes the fourth sidewall surrounding the first housing 11, so that the second housing 21 and the metal frame 24 jointly define the accommodation space P2 and completely surround the first housing 11. More specifically, the first sidewall WL1, the second sidewall WL2, the third sidewall WL3, and the metal frame 24 form four continuous sidewalls surrounding the second accommodating space P2. In other embodiments, the first housing 11 is electrically connected to a ground potential of the circuit board, and the metal frame 24 is electrically connected to the first housing 11 to achieve a shielding effect, thereby enhancing the ability of the electrical connector assembly D to resist electromagnetic interference when transmitting high-frequency signals.

Reference is further made to FIG. 2. The metal frame 24 is bent to form a U-shaped structure. The metal frame 24 includes a first metal section 241, a second metal section 242, and a third metal section 243. The second metal section 242 and the third metal section 243 are connected to both ends of the first metal section 241, respectively. A side edge of the first metal section 241 is provided with a plurality of limiting convex portions 245. Each of the second metal section 242 and the third metal section 243 includes a cantilever 244. The two cantilevers 244 are concave (i.e., the two cantilevers 244 are bent toward each other) and have elasticity. Each of two sides of the second housing 21 includes two retaining grooves 216, respectively. Specifically, each of the retaining grooves 216 is a strip-shaped groove. As shown in FIGS. 1 and 2, the metal frame 24 is assembled to the second housing 21 along a first direction (i.e., a negative X-axis direction). More specifically, the metal frame 24 is assembled to the second housing 21 along the edges of the second sidewall WL2 and the third sidewall WL3. The limiting convex portions 245 extend in the first direction. As shown in FIG. 3, a bottom of the second housing 21 has a plurality of limiting holes V that correspond to the plurality of limiting convex portions 245, respectively. When the metal frame 24 is assembled to the second housing 21 along the first direction, the plurality of limiting convex portions 245 are engaged with the plurality of limiting holes V, respectively.

The second metal section 242 and the third metal section 243 are detachably assembled to the second sidewall WL2 and the third sidewall WL3, respectively. Specifically, each of the second metal section 242 and the third metal section 243 includes a hook portion 246. Each of the hook portions 246 is located adjacent to a corresponding one of the cantilevers 244. The second housing 21 is provided with two cutting grooves 217 on both sides of the second accommodating space P2. When the metal frame 24 is assembled to the second housing 21, the two hook portions 246 are respectively inserted into the two cutting grooves 217 to hook the second sidewall WL2 and the third sidewall WL3, respectively, thereby preventing the second metal section 242 and the third metal section 243 of the metal frame 24 from being bent outward (i.e., respectively bent in a positive and a negative Y-axis directions) and separated from the second housing 21 when an external force is exerted.

Moreover, when the metal frame 24 is assembled to the second housing 21 along the first direction, the two cantilevers 244 are engaged with the two retaining grooves 216, respectively. Furthermore, the retaining grooves 216 limits the cantilevers 244 in a positive X-axis direction. That is, the metal frame is unable to withdraw in a second direction (i.e., the positive X-axis direction) that is opposite to the first direction. When the metal frame 24 moves in the positive X-axis direction, the cantilevers 244 that are concave abut against the retaining grooves 216.

Reference is made to FIG. 2 and FIG. 4. The wire end connector 2 further includes an elastic buckle 25, a pull strap 26, a retaining member 27, and a mating plate 29. The mating plate 29 is at least partially located in the accommodating space P2 and located between the first sidewall WL1 and the tongue plate 22. The elastic buckle 25 includes a fixing end 25A and a free end 25B. The fixing end 25A is mounted on the mating plate 29, and the free end 25B protrudes from an outer surface of the first sidewall WL1. The tongue plate 22, the mating plate 29, and the fixing end 25A of the elastic buckle 25 are located in the second accommodating space P2. In order to clearly illustrate the elastic buckle 25 and the retaining member 27, the pull strap 26 is omitted in FIG. 4, and the structural configuration of the pull strap 26 can be shown in FIGS. 2 and 3. The second housing 21 further includes an aperture 211 and a fixing column 212. The aperture 211 is disposed on the first sidewall WL1, and at least one protrusion 251 on a surface of the elastic buckle 25 is exposed from the aperture 211.

The retaining member 27 has a guiding hole 270, and the pull strap 26 includes a wrapping portion 261. A position of the guiding hole 270 is lower than that of the free end 25B of the elastic buckle 25 that is located between the guiding hole 270 and the fixing column 212. The pull strap 26 passes through the guiding hole 270 and wraps around the fixing column 212 through the wrapping portion 261, and a part of the pull strap 26 is located outside the free end 25B of the elastic buckle 25, so that the free end 25B of the elastic buckle 25 can be pressed when the pull strap 26 is pulled. A side surface of the first housing 11 has at least one snapping hole 111. When the board end connector 1 is docked with the wire end connector 2, the at least one protrusion 251 is engaged with the at least one snapping hole 111, such that the board end connector 1 and the wire end connector 2 are fixed with each other. When the pull strap 26 is pulled, the at least one protrusion 251 moves downward and away from the snapping hole 111, so that the wire end connector 2 can be separated from the board end connector 1 and the docking state is released.

As shown in FIG. 4, the retaining member 27 further includes a guiding arm 271 and a positioning arm 272. The guiding arm 271 is perpendicular to the positioning arm 272. The second housing 21 further includes a mounting groove 213 and an extension portion 214 that is disposed on a lower side of the mounting groove 213. The tongue plate 22 is inserted into the second housing 21 from the mounting groove 213 and exposed to the second accommodating space P2. The guiding arm 271 is inserted into the second housing 21 from the mounting groove 213, and the positioning arm 272 abuts against the extension portion 214 outwardly. Furthermore, the retaining member 27 further includes a plurality of bumps 273 that are disposed on the guide arm 271 and the positioning arm 272. Both sides of the second housing 21 also include a plurality of trench holes 215. When the retaining member 27 is disposed on the second housing 21, the plurality of bumps 273 are respectively engaged with the plurality of trench holes 215 to fix the retaining member 27 to the second housing 21.

Reference is further made to FIGS. 5 and 6. The board end connector 1 in FIGS. 5 and 6 is a vertical socket connector, while the wire end connector 2 is a plug connector. Therefore, the board end connector 1 is disposed upright on the circuit board (not shown in the figures) that is located on a Y-Z plane, and the socket of the board end connector 1 is arranged toward the negative X-axis direction. A first accommodating space P1 is formed between the first housing 11 and a side surface of the terminal base 13. When the wire end connector 2 is vertically docked with the board end connector 1 along the second direction (i.e., the positive X-axis direction), the tongue plate 22 is inserted into the slot 130 of the terminal base 13, and the mating plate 29 is inserted into the first accommodating space P1. The first housing 11 is inserted into the second accommodating space P2, so that the second housing 21 at least partially surrounds the first housing 11. The board end connector 1 and the wire end connector 2 that are docked with each other jointly form the electrical connector assembly D of the present disclosure.

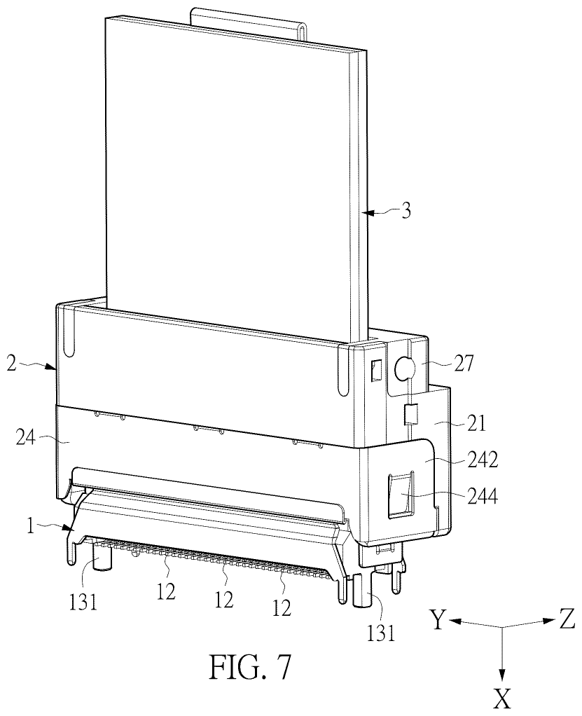

As shown in FIG. 7, since the wire end connector 2 is plugged vertically into the board end connector 1, the cable assembly 3 has no structure on which it can lean and be fixed. Therefore, the cable assembly 3 is easily shaken or bent, causing the connection between the board end connector 1 and the wire end connector 2 to be unstable, thereby affecting the stability of signal transmission. Therefore, in the present disclosure, by assembling a metal frame 24 onto the second housing 21, the board end connector 1 is completely surrounded by the second housing 21 and the metal frame 24. In appearance, the board end connector 1 is almost completely inserted into the wire end connector 2, and only the parts that are fixedly connected to the circuit board are exposed from the wire end connector 2, thereby strengthening the engaged structure between the board end connector 1 and the wire end connector 2. The connection strength between the two connectors (i.e., the board end connector 1 and the wire end connector 2) is not affected by shaking or bending of the cable assembly 3, thereby improving the stability of signal transmission.

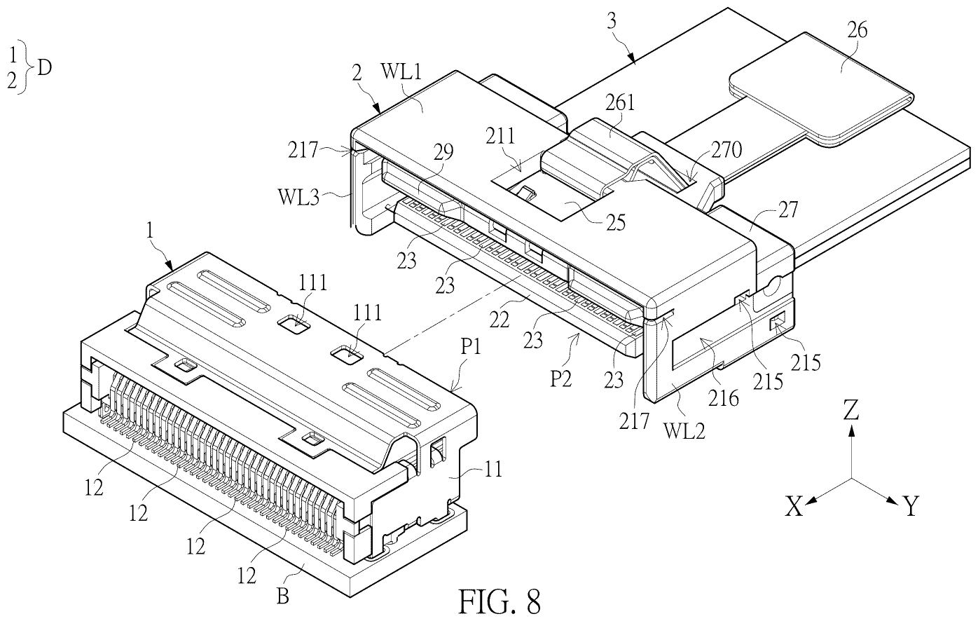

However, the aforementioned descriptions for the board end connector 1 and the wire end connector 2 of the first embodiment is merely an example, and is not meant to limit the scope of the present disclosure. Reference is made to FIG. 8. FIG. 8 is a schematic view of a second implementation of the wire end connector and the board end connector according to the first embodiment of the present disclosure. The board end connector 1 can be a right-angle socket connector. That is, the board end connector 1 is disposed on the circuit board B that is located on an X-Y plane, and the socket of the board end connector 1 is arranged in the negative X-axis direction. It should be noted that the size of the circuit board B in FIG. 8 is for illustration purposes only and does not represent the actual size. The circuit board B can be extended to the wire end connector 2. Therefore, the cable assembly 3 in FIG. 8 is parallel to the circuit board B. The cable assembly 3 can be placed on the circuit board B, and the connection between the board end connector 1 and the wire end connector 2 is not easily affected by bending.

In other words, the wire end connector 2 of the present disclosure can be adapted to different types of board end connectors 1 (i.e., vertical type or right-angle type). Since the cable assembly 3 is not bent to affect signal transmission when the wire end connector 2 is docked with the right-angle board end connector 1, the metal frame 24 can be detached from the wire end connector 2. That is, there is no need for the metal frame 24 to strengthen the engaged structure between the wire end connector 2 and the right-angle board end connector 1.

### Second Embodiment

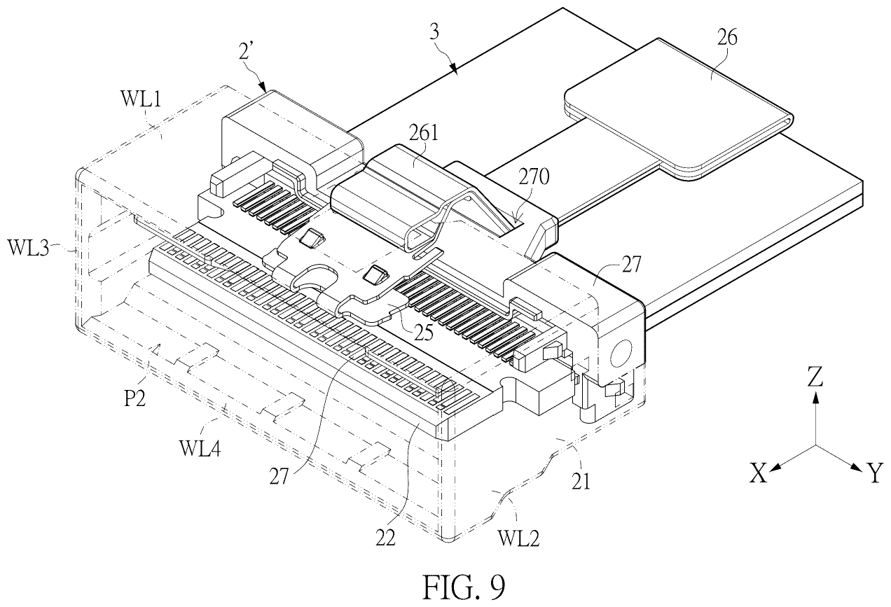

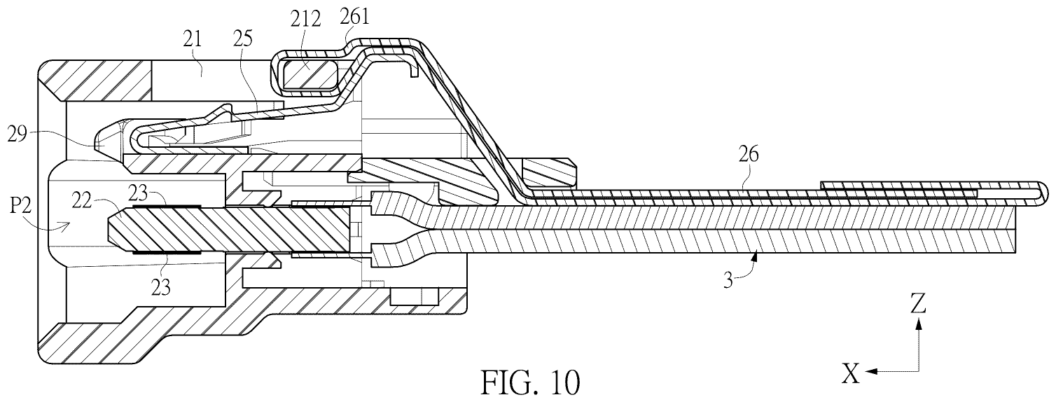

Reference is made to FIG. 9 and FIG. 10. FIG. 9 is a schematic view of a wire end connector according to a second embodiment of the present disclosure. FIG. 10 is a schematic cross-sectional view of the wire end connector according to the second embodiment of the present disclosure. The wire end connector 2′ in the second embodiment has a structure similar to that of the wire end connector 2 in the first embodiment, and the similarities therebetween will not be reiterated herein. The main difference between the second embodiment and the first embodiment is that the second accommodating space P2 of the second housing 21 of the wire end connector 2′ is defined by four integrally formed sidewalls, which includes the first sidewall WL1, the second sidewall WL2, the third sidewall WL3, and the fourth sidewall WL4. That is, the wire end connector 2′ eliminates the metal frame.

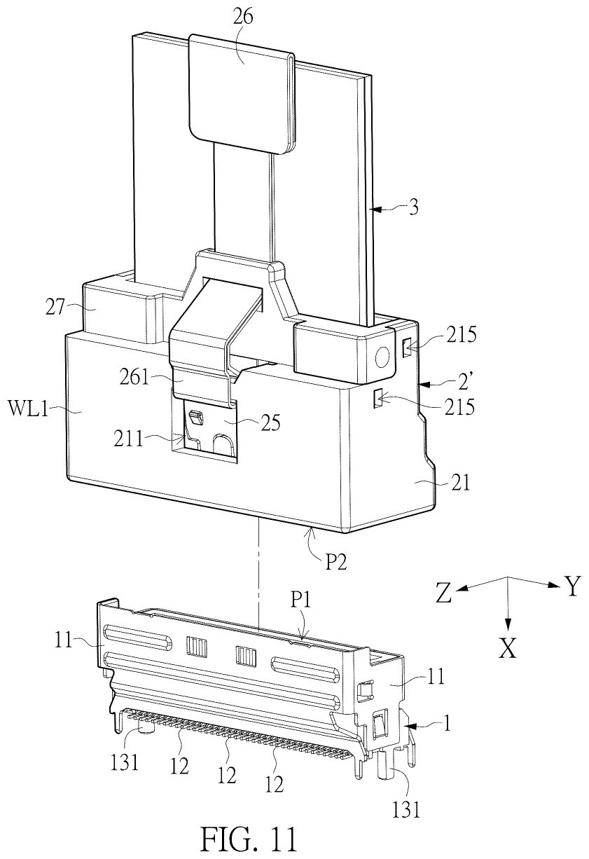

Reference is made to FIG. 11, which is a schematic view of the wire end connector and a board end connector according to the second embodiment of the present disclosure. The board end connector 11 is disposed upright on a circuit board (not shown in the figures) located on a Y-Z plane. When the wire end connector 2′ is docked with the vertical type of board end connector 1, the board end connector 1 is almost completely surrounded by the second housing 21. In appearance, the board end connector 1 is almost completely inserted into the wire end connector 2, and only the parts that are fixedly connected to the circuit board are exposed from the wire end connector 2. Therefore, the engaged structure between the board end connector 1 and the wire end connector 2 can be strengthened to ensure that the connection strength between the two connectors (i.e., the board end connector 1 and the wire end connector 2) is not affected by the shaking or bending of the cable assembly 3, thereby improving the stability of signal transmission.

### Third Embodiment

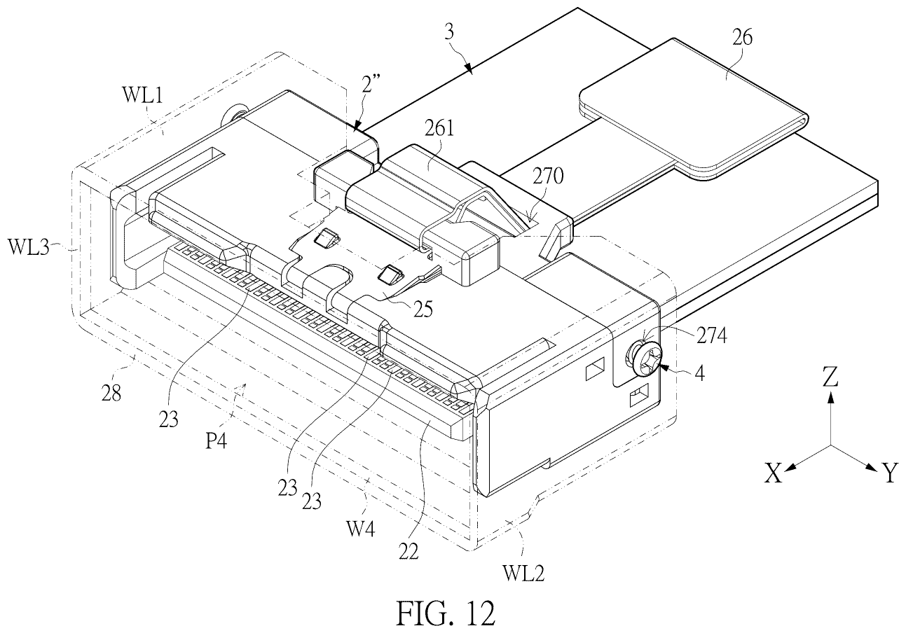

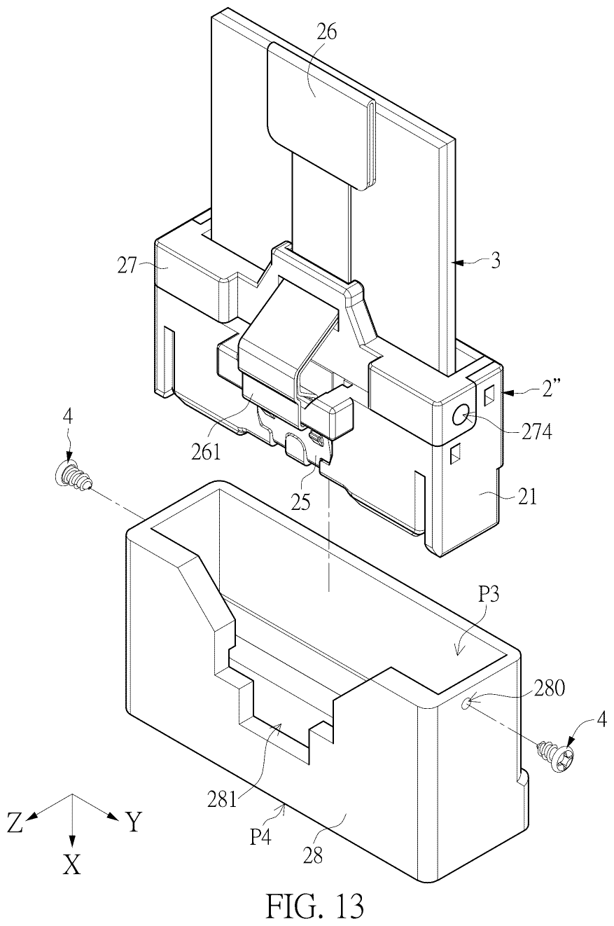

Reference is made to FIG. 12 and FIG. 13. FIG. 12 is a schematic view of a wire end connector according to a third embodiment of the present disclosure. FIG. 13 is a partial schematic exploded view of the wire end connector according to the third embodiment of the present disclosure. The wire end connector 2″ in the third embodiment has a structure similar to that of the wire end connector 2 in the first embodiment, and the similarities therebetween will not be reiterated herein. The main difference between the third embodiment and the first embodiment is that the wire end connector 2″ further includes an insulative housing 28.

The insulative housing 28 includes a third opening P3 and a fourth opening P4 that are opposite to each other. The third opening P3 and the fourth opening P4 are interconnected with each other. A side of the insulative housing 28 that is provided with the third opening P3 further includes a recess 281. The insulative housing 28 is detachably assembled on the wire end connector 2″. Specifically, the second housing 21 is inserted through the third opening P3, such that the insulative housing 28 completely surrounds the second housing 21. A front end of the second housing 21 is disposed in the insulative housing 28, and at least part of the elastic buckle 25 (e.g., a rear end) is exposed from the recess 281. Both sides of the insulative housing 28 have a plurality of through holes 280, and both sides of the holding member 27 have a plurality of threaded holes 274 that respectively correspond to the plurality of through holes 280. The insulative housing 28 is fixed on the wire end connector 2″ by using a plurality of screws 4 passing through the plurality of through holes 280 and the plurality of threaded holes 274.

When the wire end connector 2″ is docked with a vertical type of board end connector (not shown in the figures), the board end connector is inserted into the wire end connector 2″ from the fourth opening P4 and is docked with the second housing 21, such that conductive terminals of the board end connector are electrically connected to contact pads of the wire end connector 2″ for signal transmission. Since the fourth opening P4 of the insulative housing 28 is composed of four sidewalls, which includes the first sidewall WL1, the second sidewall WL2, the third sidewall WL3, and the fourth sidewall WL4, the board end connector is completely surrounded by the insulative housing 28, the engaged structure between the board end connector and the wire end connector 2″ can be strengthened to ensure that the connection strength between the two connectors (i.e., the board end connector and the wire end connector 2″) is not affected by the shaking or bending of the cable assembly 3, thereby improving the stability of signal transmission.

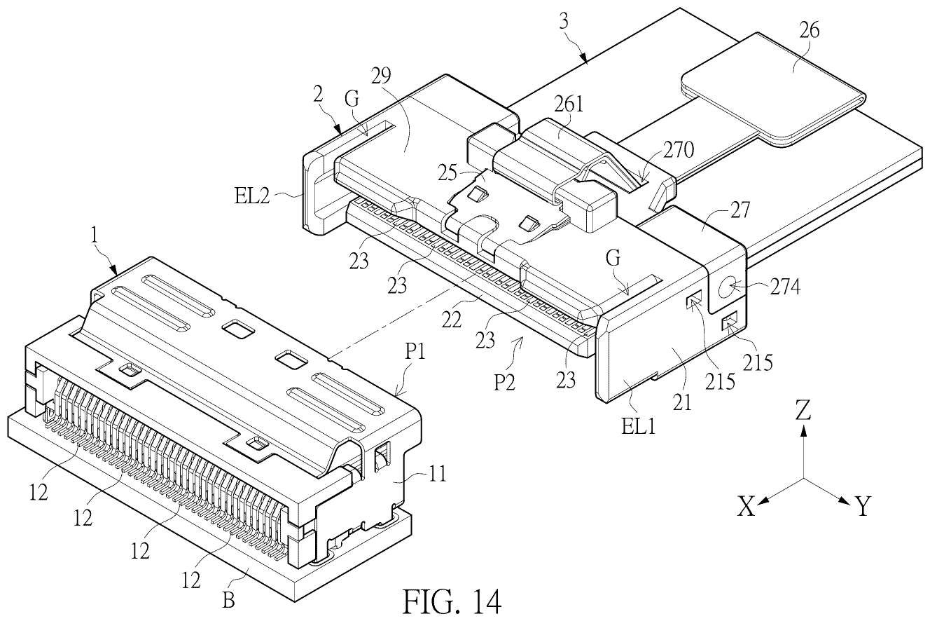

Reference is made to FIG. 14. FIG. 14 is a schematic view of the wire end connector and a board end connector according to the third embodiment of the present disclosure. FIG. 14 shows the implementation of the wire end connector 2″ being docked with the right-angle type of board end connector 1. The second housing 21 includes a mating plate 29, a first edge wall EL1 and a second edge wall EL2. Furthermore, a gap G exists between the mating plate 29 and the first edge wall EL1, and another gap G exists between the mating plate 29 and the second edge wall EL2. The two gaps G accommodate two sidewalls of the first housing 11 of the board end connector 1, respectively. When the wire end connector 2″ is docked with the right-angle type of board end connector 1, the insulative housing 28 needs to be detached from the wire end connector 2″, and then the wire end connector 2″ is docked with the board end connector 1 along the second direction (i.e., the positive X-axis direction), such that the board end connector 1 fixed on the circuit board B is inserted into the second accommodating space P2 of the second housing 21 to complete the docking. In the meantime, the first edge wall EL1 and the second edge wall EL2 are located outside the first housing 11, and the mating plate 29 is located inside the first housing 11.

### Beneficial Effects of the Embodiments

In the electrical connector assembly and the wire end connector thereof provided by the present disclosure, through the structural design of the second housing at least partially covering the first housing, the structural strength of board end connector docking with the wire end connector can be strengthened, so as to improve the stability of signal transmission.

Moreover, in the present disclosure, by assembling a metal frame 24 onto the second housing 21, the board end connector 1 is completely surrounded by the wire end connector 2, 2′, or 2″. In appearance, the board end connector 1 is almost completely inserted into the wire end connector 2, and only the parts that are fixedly connected to the circuit board are exposed from the wire end connector 2, thereby strengthening the engaged structure between the board end connector 1 and the wire end connector 2. The connection strength between the two connectors (i.e., the board end connector 1 and the wire end connector 2) is not affected by shaking or bending of the cable assembly 3, thereby improving the stability of signal transmission.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An electrical connector assembly, comprising:
a board end connector, wherein the board end connector is used for being electrically connected a circuit board, the board end connector includes a first housing, a slot, and a plurality of conductive terminals, and the plurality of conductive terminals are disposed in the slot;
a wire end connector detachably docked with the board end connector, wherein the wire end connector includes a second housing and a tongue plate, the wire end connector has four sidewalls to jointly define an accommodating space, the tongue plate is disposed in the accommodating space and used for being connected to a cable assembly, and a surface of the tongue plate is provided with a plurality of contact pads;
wherein, when the board end connector is docked with the wire end connector, the tongue plate is inserted into the slot, such that the plurality of contact pads electrically contact the plurality of conductive terminals, and the first housing is inserted into the accommodating space.

2. The electrical connector assembly according to claim 1, wherein the second housing includes a first sidewall, a second sidewall, and a third sidewall, the wire end connector further includes a metal frame, the first sidewall is connected between the second sidewall and the third sidewall, the metal frame is detachably assembled to the second housing, such that the metal frame, the first sidewall, the second sidewall, and the third sidewall jointly define the accommodating space.

3. The electrical connector assembly according to claim 2, wherein the metal frame is bent to form a U-shaped structure, the metal frame includes a first metal section, a second metal section, and a third metal section, the second metal section and the third metal section are connected to both ends of the first metal section, respectively, and the second metal section and the third metal section are detachably assembled to the second sidewall and the third sidewall, respectively.

4. The electrical connector assembly according to claim 3, wherein each of the second metal section and the third metal section includes a cantilever, each of two sides of the second housing includes two retaining grooves, respectively; wherein the metal frame is assembled to the second housing along a first direction, and the two cantilevers are engaged with the two retaining grooves, respectively, such that the metal frame is unable to withdraw in a second direction that is opposite to the first direction.

5. The electrical connector assembly according to claim 4, wherein a side edge of the first metal section is provided with a plurality of limiting convex portions, the second housing has a plurality of limiting holes that correspond to the plurality of limiting convex portions, respectively; wherein, when the metal frame is assembled to the second housing along the first direction, the plurality of limiting convex portions are engaged with the plurality of limiting holes, respectively.

6. The electrical connector assembly according to claim 1, wherein the first housing is made of conductive material.

7. The electrical connector assembly according to claim 1, wherein the wire end connector further includes an elastic buckle, a pull strap, and a retaining member, the second housing further includes a fixing column, the retaining member has a guiding hole, the elastic buckle is disposed on the second housing, the pull strap passes through the guiding hole and wraps the fixing column, and the pull strap is located outside the elastic buckle.

8. The electrical connector assembly according to claim 1, wherein the second housing includes a first sidewall, a second sidewall, a third sidewall, and a fourth sidewall that are integrally formed, the first sidewall and the fourth sidewall are connected between the second sidewall and the third sidewall, and the first sidewall, the second sidewall, the third sidewall, and the fourth sidewall jointly form the accommodating space.

9. The electrical connector assembly according to claim 1, wherein the wire end connector further includes an insulative casing, the second housing is disposed in the insulative casing, the insulative casing has an opening, and the board end connector is inserted into the wire end connector from the opening, such that the insulative casing completely surrounds the second housing.

10. The electrical connector assembly according to claim 9, wherein both sides of the insulative casing have a plurality of through holes, both sides of the second housing have a plurality of through holes, and the insulative casing is fixed to the wire end connector by a plurality of screws passing through the through holes and the through holes.

11. The electrical connector assembly according to claim 1, wherein the wire end connector further includes a mating plate, the mating plate is at least partially located in the accommodating space, and the board end connector further includes another accommodating space; wherein, when the wire end connector is docked with the board end connector, the mating plate is inserted into the another accommodating space.

12. The electrical connector assembly according to claim 11, wherein the wire end connector further includes an elastic buckle, the elastic buckle is assembled to the mating plate and has at least one protrusion, and the first housing has at least one snapping hole; wherein, when the wire end connector is docked with the board end connector, the at least one protrusion is engaged with the at least one snapping hole.

13. A wire end connector, comprising:
a housing assembly having four sidewalls to enclose an accommodating space;
a tongue plate, wherein a part of the tongue plate is disposed in the housing assembly and electrically connected to a cable assembly, and another part of the tongue plate is exposed to the accommodating space and provided with a plurality of contact pads; and
an elastic buckle including a fixing end and a free end, wherein the fixing end is fixed on the housing assembly and located in the accommodating space, and the free end protrudes from the four sidewalls.

14. The wire end connector according to claim 13, wherein the housing assembly further includes a mating plate, and the fixing end of the elastic buckle is fixed on the mating plate.

15. The wire end connector according to claim 13, wherein the housing assembly includes an insulative housing and a metal frame, the insulative housing has a first sidewall, a second sidewall, and a third sidewall, the first sidewall is connected between the second sidewall and the third sidewall, the metal frame is detachably assembled to the insulative housing, such that the metal frame, the first sidewall, the second sidewall, and the third sidewall jointly define the accommodating space.

16. The wire end connector according to claim 13, wherein a surface of the elastic buckle includes at least one protrusion, one of the four sidewalls has an aperture, the elastic buckle is disposed on the housing assembly, and the at least one protrusion is exposed from the aperture.

17. The wire end connector according to claim 13, further comprising a pull strap, wherein the housing assembly further includes a fixing column and a guiding hole, the free end of the elastic buckle is located between the guiding hole and the fixing column, the pull strap passes through the guiding hole and wraps the fixing column, and the pull strap is located outside the elastic buckle.

18. The wire end connector according to claim 13, wherein the housing assembly includes an insulative housing, the insulative housing has a mating plate, a first edge wall and a second edge wall, a gap exists between the mating plate and the first edge wall, and another gap exists between the mating plate and the second edge wall.
